(19) United States
(12) Patent Application Publication
(10) Pub. No.: US 2009/0284520 A1
(43) Pub. Date: Nov. 19, 2009

(54) PLASMA DISPLAY AND DRIVING METHOD THEREOF

(76) Inventors: Seung-Pil Mun, Suwon-si (KR); Chan-Kyu Jang, Suwon-si (KR); Loo-Ney Choi, Suwon-si (KR)

Correspondence Address: CHRISTIE, PARKER & HALE, LLP, PO BOX 7068, PASADENA, CA, 91109-7068, US

(21) Appl. No.: 12/465,491

(22) Filed: May 13, 2009

(30) Foreign Application Priority Data
May 15, 2008 (KR) 10-2008-0045089

(51) Int. Cl. G06F 3/038; G09G 3/28

(52) U.S. Cl. 345/213; 345/60

(57) ABSTRACT

A plasma display and a driving method thereof is provided. The plasma display includes a sustain electrode, a first switch coupling a first power source with a first voltage to the sustain electrode, a second switch coupling a second power source with a second voltage lower than the first voltage to the sustain electrode, an inductor, a power recovery capacitor, a third switch, and a fourth switch. The inductor is coupled to the sustain electrode. The power recovery capacitor is charged with a third voltage between the first and second voltages in a first subfield, and charged with a fourth voltage that is higher than the third voltage in a second subfield. The third and fourth switches couple the inductor to the power recovery capacitor, and are turned on in address periods of the first and second subfields to apply the third and fourth voltages, respectively, to the sustain electrode.

### CROSS-REFERENCE TO RELATED APPLICATION

This application claims priority to and the benefit of Korean Patent Application No. 10-2008-0045089 filed in the Korean Intellectual Property Office on May 15, 2008, the entire content of which is incorporated herein by reference.

### BACKGROUND OF THE INVENTION

1. Field of the Invention

The present invention relates to a plasma display and a driving method thereof.

2. Description of the Related Art

A plasma display panel (PDP) is a flat panel display that uses plasma generated by gas discharge to display characters or images. It includes, depending on its size, from hundreds of thousands to millions of pixels arranged in a matrix pattern. One frame (e.g., 1 TV field) of an image for such a plasma display is divided into a plurality of subfields having weight values, and each subfield includes a reset period, an address period, and a sustain period.

The reset period is a period for initializing or resetting a state of each cell so as to smoothly perform a subsequent address operation in a cell. The address period is a period for selecting which cells among a plurality of cells are to emit light through an address discharge. The sustain period is for causing a discharge in the addressed cells for displaying an image.

During a portion of the reset period and the address period, a Ve voltage is applied to a sustain electrode. A Ve power source supplies the Ve voltage to the sustain electrode. A plurality of transistors are typically provided between the Ve power source and the sustain electrode.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides generally for a plasma display, and more specifically for a plasma display and display driving method including a simplified configuration.

According to an embodiment of the present invention, a driving method of a plasma display is provided. The plasma display may include a sustain electrode for forming a panel capacitor, an inductor having a first terminal coupled to the sustain electrode, and a power recovery capacitor having a first terminal coupled to a second terminal of the inductor. In the driving method, a first voltage is charged in the power recovery capacitor in an address period of a first subfield, a first current path is formed through the power recovery capacitor, the inductor, and the panel capacitor in the address period of the first subfield; a second current path is formed through the panel capacitor, the inductor, and the power recovery capacitor in the address period of the first subfield; current is repeatedly passed through the first current path and the second current path by utilizing resonance between the inductor and the panel capacitor to apply the first voltage to the sustain electrode in the address period of the first subfield; a second voltage that is higher than the first voltage is charged in the power recovery capacitor in an address period of a second subfield having a weight value greater than a weight value of the first subfield; a third current path is formed through the power recovery capacitor, the inductor, and the panel capacitor in the address period of the second subfield; a fourth current path is formed through the panel capacitor, the inductor, and the power recovery capacitor in the address period of the second subfield; and current is repeatedly passed through the third current path and the fourth current path by utilizing resonance between the inductor and the panel capacitor to apply the second voltage to the sustain electrode in the address period of the second subfield.

According to another embodiment of the present invention, a plasma display may include a sustain electrode, a first switch, a second switch, an inductor, a power recovery capacitor, a third switch, and a fourth switch. The first switch is coupled between the sustain electrode and a first power source for supplying a first voltage. The second switch is coupled between the sustain electrode and a second power source for supplying a second voltage that is lower than the first voltage. The inductor has a first terminal coupled to the sustain electrode. The power recovery capacitor is configured to be charged with a third voltage between the first and second voltages in a first subfield, and configured to be charged with a fourth voltage that is higher than the third voltage in a second subfield having a weight value greater than a weight value of the first subfield. The third switch has a first terminal coupled to a second terminal of the inductor and a second terminal coupled to the power recovery capacitor. The fourth switch has a first terminal coupled to the second terminal of the inductor and a second terminal coupled to the power recovery capacitor. In this case, the third and fourth switches are configured to be turned on in an address period of the first subfield to apply the third voltage to the sustain electrode, and the third and fourth switches are configured to be turned on in an address period of the second subfield to apply the fourth voltage to the sustain electrode.

These and other embodiments of the present invention are more fully comprehended upon review of the disclosure.

### BRIEF DESCRIPTION OF THE DRAWINGS

FIG. 1 is a block diagram of a plasma display according to an exemplary embodiment of the present invention.

FIG. 2 is a waveform diagram representing a driving method of the plasma display according to a first exemplary embodiment of the present invention.

FIG. 3 is a schematic circuit diagram representing a driving circuit of a sustain electrode driver according to an exemplary embodiment of the present invention.

FIG. 4 is a waveform diagram representing driving timing of the driving circuit shown in FIG. 3.

FIGS. 5, 6, and 7 show schematic circuit diagrams representing current paths in the driving circuit shown in FIG. 3.

FIG. 8 is a diagram representing a waveform of an X electrode of the plasma display according to a second exemplary embodiment of the present invention.

### DETAILED DESCRIPTION OF THE EMBODIMENTS

In the following detailed description, only certain exemplary embodiments of the present invention are shown and described, simply by way of illustration. As those skilled in the art will recognize, the described embodiments may be modified in various ways without departing from the spirit or scope of the present invention. Accordingly, the drawings and description are to be regarded as illustrative in nature, rather than restrictive. Like elements are denoted by like reference numerals throughout the specification.

Throughout this specification and the claims that follow, when it is described that an element is “coupled” to another element, the element may be “directly coupled” to the other element or “electrically coupled” to the other element via one or more additional elements. In addition, unless explicitly described to the contrary, the word “comprise” and variations such as “comprises” or “comprising” will be understood to imply the inclusion of stated elements but not the exclusion of any other elements.

Further, a “wall charge” refers to a charge that is formed on a wall (for example, a dielectric layer) of a discharge cell close to an electrode to be stored on the electrode. Even though the wall charge is not actually in contact with the electrode, hereinafter it may be described that the wall charge is formed, accumulated, or stacked on the electrode. Further, a ‘wall voltage’ refers to a potential difference generated on a wall of a discharge cell by the wall charge.

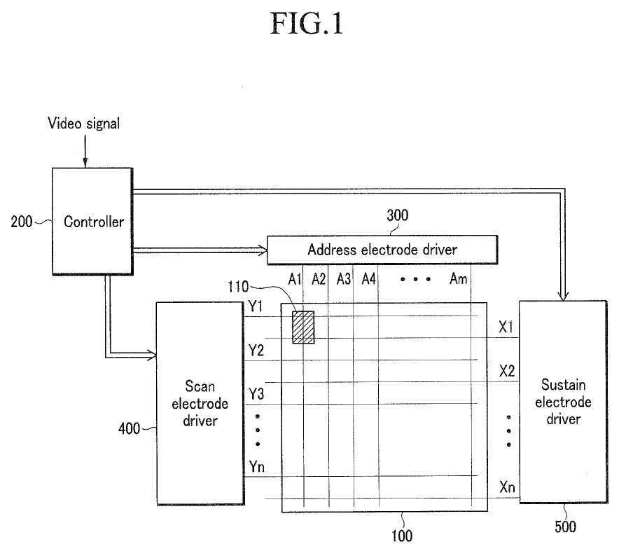

FIG. 1 is a block diagram of a plasma display according to an exemplary embodiment of the present invention.

As shown in FIG. 1, the plasma display includes a plasma display panel (“PDP”) 100, a controller 200, an address electrode driver 300, a scan electrode driver 400, and a sustain electrode driver 500.

The PDP 100 includes a plurality of address electrodes A1 to Am extending in a vertical or column direction, and a plurality of sustain and scan electrodes X1 to Xn and Y1 to Yn extending in a horizontal or row direction, arranged in pairs. In general, each of the sustain electrodes X1 to Xn are paired with a corresponding scan electrode Y1 to Yn, respectively. The sustain electrodes and scan electrodes perform a display operation for displaying an image during the sustain period. The scan electrodes Y1 to Yn and the sustain electrodes X1 to Xn cross the address electrodes A1 to Am. Discharge spaces where an address electrode crosses a sustain and scan electrode pair form cells, for example, cell 110. It is to be noted that the construction of the PDP is only an example, and panels having different structures, to which a driving waveform to be described later can be applied, may be applied to the present invention.

The controller 200 receives an external video signal, and outputs address electrode driving control signals, sustain electrode driving control signals, and scan electrode driving control signals. The controller 200 drives one frame that is divided into a plurality of subfields. Each subfield includes a reset period, an address period, and a sustain period.

In addition, in the exemplary embodiment of the present invention, the controller 200 transmits a control signal for controlling a voltage applied to the sustain electrode during a falling period of the reset period and the address period. In some embodiments the applied voltage may be a Vs/2 voltage that is lower than a sustain discharge voltage Vs.

The address electrode driver 300 receives an address electrode driving control signal from the controller 200, and applies a display data signal for selecting discharge cells on which an image will be displayed to each electrode.

The scan electrode driver 400 receives a scan electrode driving control signal from the controller 200, and applies a driving voltage to the scan electrode.

The sustain electrode driver 500 receives a sustain electrode driving control signal from the controller 200, and applies a driving voltage to the sustain electrode.

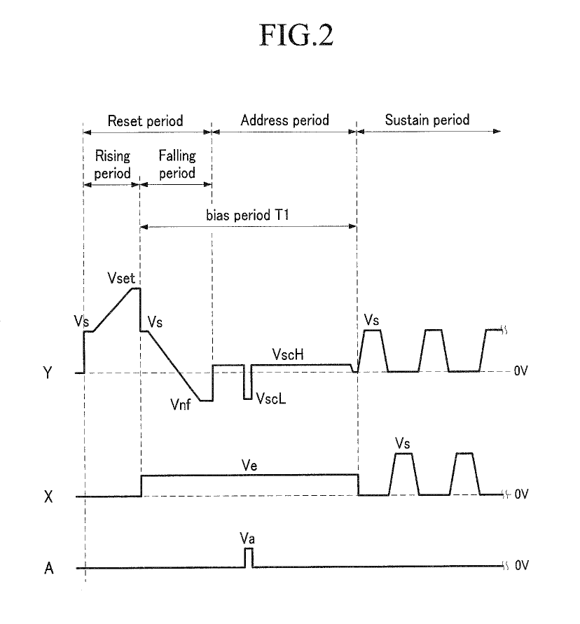

Driving waveforms of the plasma display according to an exemplary embodiment of the present invention will be described with reference to FIG. 2. Hereinafter, for better understanding and ease of description, the driving waveform applied to an address electrode (“A electrode”), a sustain electrode (“X electrode”), and a scan electrode (“Y electrode”) forming one cell, for example, cell 110 in FIG. 1, will be described.

FIG. 2 is a waveform diagram representing a driving method of the plasma display according to a first exemplary embodiment of the present invention.

As shown in FIG. 2, during the rising period of the reset period, voltages at the X and A electrodes are respectively maintained to be a reference voltage (in FIG. 2, the reference voltage is assumed to be a ground voltage 0V), and a voltage at the Y electrode is gradually increased from a Vs voltage to a Vset voltage. When the voltage at the Y electrode is increased, a weak discharge is generated between the Y and X electrodes and the Y and A electrodes, negative wall charges are formed on the Y electrode, and positive wall charges are formed on the X and A electrodes.

During the falling period of the reset period, while the voltages at the A and X electrodes are respectively maintained to be the reference voltage and a Ve voltage, the voltage at the Y electrode is gradually decreased from the Vs voltage to a Vnf voltage. Accordingly, a weak discharge is generated between the Y and X electrodes and between the Y and A electrodes, and therefore the negative wall charges formed on the Y electrode and the positive wall charges formed on the X and A electrodes are eliminated. In general, a voltage of (Vnf-Ve) is set to be close to a discharge firing voltage Vfxy between the Y electrode and the X electrode. Thereby, since a wall voltage between the Y and X electrodes becomes close to 0V, a cell in which an address discharge is generated during the address period may be prevented from being misfired during the sustain period.

During the address period, to select a turn-on discharge cell, while the Ve voltage is applied to the X electrode, a scan pulse having a VscL voltage is sequentially applied to the plurality of Y electrodes. Concurrently, a Va voltage is applied to the A electrode passing through a discharge cell which will emit light among the plurality of discharge cells formed by the Y electrode receiving the VscL voltage and the X electrode. Thereby, the address discharge is generated between the A electrode receiving the Va voltage and the Y electrode receiving the VscL voltage, and between the Y electrode receiving the VscL voltage and the X electrode receiving the Ve voltage. Accordingly, the positive wall charges are formed on the Y electrode, and the negative wall charges are formed on the A electrode and the X electrode. Here, a VscH that is higher than the VscL voltage is applied to the Y electrode to which the VscL voltage is not applied, and the reference voltage is applied to the A electrode of the discharge cell that is not selected.

In addition, to perform the above operation during the address period, the scan electrode driver 400 selects the Y electrode to which the scan pulse having the VscL voltage is applied among the Y electrodes Y1 to Yn. For example, each Y electrode may be selected sequentially in a vertical direction in the single driving method. When one Y electrode is selected, the address electrode driver 300 selects turn-on discharge cells among the discharge cells formed by the corresponding Y electrode. That is, the address buffer board 100 selects the A electrodes to which the address pulse having the Va voltage is applied based on the corresponding selected cells along the selected Y electrode.

During the sustain period, a sustain pulse alternately having a high level voltage (the Vs voltage in FIG. 2) and a low level voltage (the 0V in FIG. 2) is applied to the Y and X electrodes. Here, the sustain pulse applied to the Y electrode has an opposite phase to that applied to the X electrode. When the Vs voltage is applied to the Y electrode and the 0V voltage is applied to the X electrode, a sustain discharge is generated between the Y electrode and the X electrode. That is, negative wall charges are formed on the Y electrode and positive wall charges are formed on the X electrode. The opposite occurs when the Vs voltage is applied to the X electrode and the 0V voltage is applied to the Y electrode. An operation for applying the sustain pulse to the Y electrode and the X electrode is repeatedly performed a number of times corresponding to a weight value of the corresponding subfield. In general, the sustain pulse has a square wave having a Vs sustain interval.

As shown in FIG. 2, for better understanding and ease of description, the falling period of the reset period and the address period will be referred to as a bias period T1.

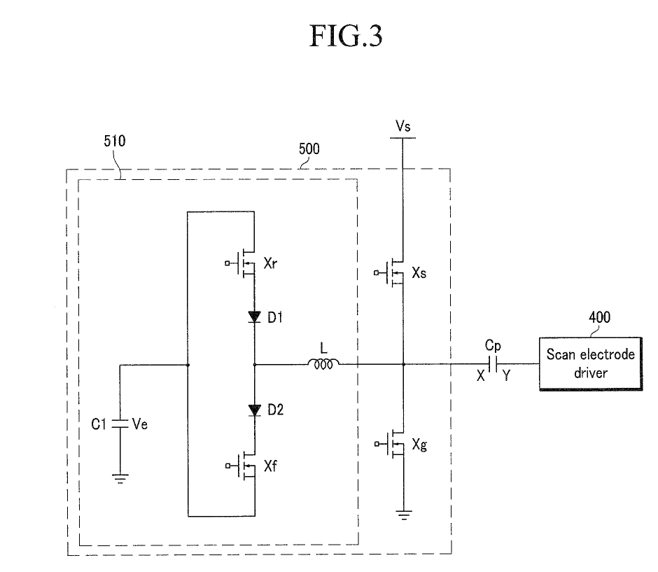

Subsequently, a driving circuit for applying the Ve voltage to the sustain electrode during the bias period T1 will be described with reference to FIG. 3 to FIG. 7. In FIG. 3 to FIG. 7, a driving circuit of the scan electrode driver 400 is illustrated only as a box, while a driving circuit of the sustain electrode driver 500 is illustrated in greater detail. In addition, while a transistor is illustrated as an n-channel transistor, the transistor may alternatively be a field effect transistor (FET) having a body diode, or the transistor may be another switch having the same or similar functions. Further, a capacitance formed by the X and Y electrodes is illustrated as a panel capacitor Cp.

FIG. 3 is a schematic circuit diagram representing a driving circuit of the sustain electrode driver according to an exemplary embodiment of the present invention.

As shown in FIG. 3, the sustain electrode driver 500 includes a power recovery unit 510 and transistors Xs and Xg. The power recovery unit 510 includes transistors Xr and Xf, an inductor L, diodes D1 and D2, and a power recovery capacitor C1.

The transistor Xs is connected between a power source Vs for supplying a Vs voltage and the X electrode of the panel capacitor Cp, and the transistor Xg is connected between a power source for supplying a 0V voltage and the X electrode of the panel capacitor Cp. In the exemplary embodiment of the present invention, the transistor Xs is used to apply the Vs voltage to the X electrode, and the transistor Xg is used to apply the 0V voltage to the X electrode.

A first terminal of the power recovery capacitor C1 is coupled to a drain of the transistor Xr and a source of the transistor Xf, and a voltage Ve is charged in the power recovery capacitor C1. In a first exemplary embodiment of the present invention, the voltage Ve may be predetermined to be a Vs/2 voltage. The voltage Ve may have other values in other embodiments. In addition, a second terminal of the inductor L having a first terminal coupled to the X electrode is coupled to a source of the transistor Xr and a drain of the transistor Xf.

Further, a diode D1 is coupled between the source of the transistor Xr and the inductor L, and a diode D2 is coupled between the drain of the transistor Xf and the inductor L. The diode D1 is used to form a rising path for increasing the voltage at the X electrode when the transistor Xr has a body diode, and the diode D2 is used to form a falling path for decreasing the voltage at the X electrode when the transistor Xf has a body diode. In this case, when the transistors Xr and Xf have no body diode, the diodes D1 and D2 may be eliminated. The power recovery unit 510 uses a resonance of the inductor L and the panel capacitor Cp to increase the voltage at the X electrode from the 0V voltage to the Vs voltage or to decrease the voltage at the X electrode from the Vs voltage to the 0V voltage.

In addition, a coupling sequence between the inductor L, the diode D2, and the transistor Xf in the power recovery unit 510 may be changed, and that between the inductor L, the diode D1, and the transistor Xr may be changed. For example, the inductor L may be coupled between a node of the transistors Xr and Xf and the power recovery capacitor C1. In addition, in FIG. 3, while the inductor L is coupled to the node of the transistors Xr and Xf, in other embodiments, for example, two inductors may be respectively coupled in the rising path formed by the transistor Xr and the falling path formed by the transistor Xf.

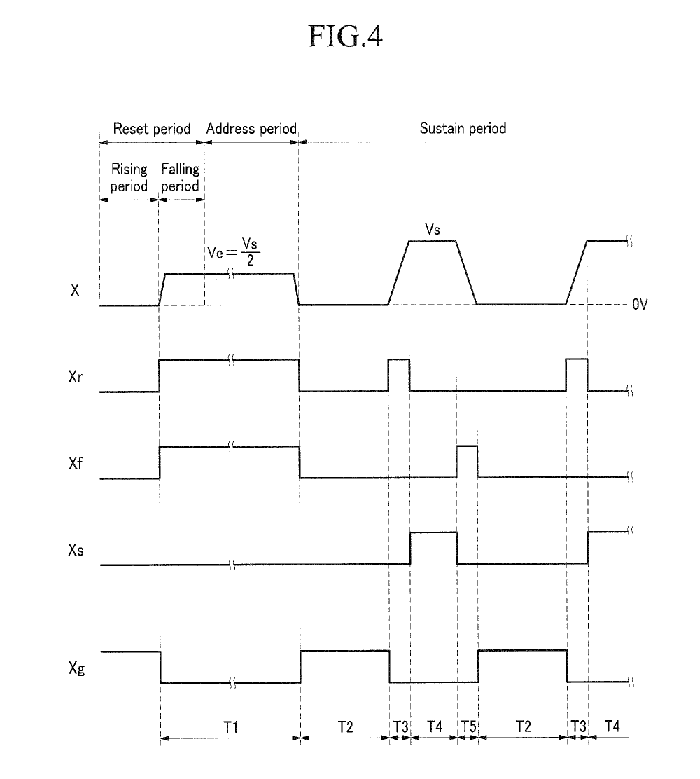

A time-variant operation of the driving circuit of the sustain electrode driver according to an exemplary embodiment of the present invention will now be described with reference to FIG. 4 to FIG. 7.

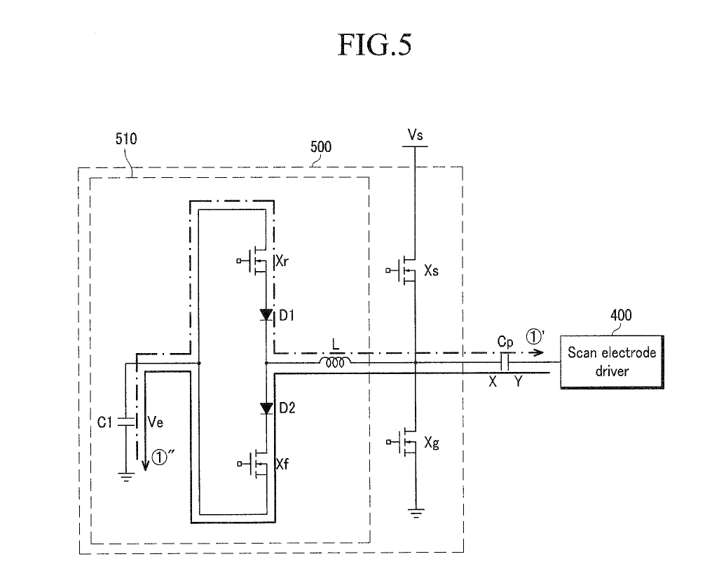

FIG. 4 is a waveform diagram of an example of driving timing of the driving circuit shown in FIG. 3, and FIG. 5 to FIG. 7 show diagrams representing current paths in the driving circuit shown in FIG. 3.

The bias period T1 includes the falling period of the reset period and the address period. Periods T3 to T5 are periods for applying a sustain pulse to the X electrode during the sustain period, and a period T2 is a period in which the sustain pulse is not applied to the X electrode during the sustain period.

It is assumed that prior to the bias period T1, the X electrode of the panel capacitor Cp is maintained at the 0V voltage since the transistor Xg is turned on, and the predetermined voltage Ve between the external voltage Vs and the external voltage 0V is previously charged in the power recovery capacitor C1. It is also assumed that the Ve voltage charged in the power recovery capacitor C1 is the Vs/2 voltage.

During the bias period T1, the transistors Xr and Xf are concurrently turned on. Thereby, as shown in FIG. 5, a current path \textcircled{1}′ including a ground, the power recovery capacitor C1, the transistor Xr, the diode D1, the inductor L, and the X electrode of the panel capacitor Cp is formed. An LC resonance circuit is formed by the current path \textcircled{1}′, and the voltage at the X electrode of the panel capacitor Cp may be increased to at or near the Vs voltage. In this case, resistive components may exist on the current path \textcircled{1}′. Therefore, the voltage at the X electrode of the panel capacitor Cp may not be increased up to the Vs voltage. Due to LC resonance, a current flows back through a current path \textcircled{1}″.

As shown in FIG. 5, the current path \textcircled{1}″ is formed, including the X electrode of the panel capacitor Cp, the inductor L, the diode D2, the transistor Xf, the power recovery capacitor C1, and ground. In this case, resistive components may exist on the current path \textcircled{1}″. Accordingly, the voltage at the X electrode of the panel capacitor Cp may not be decreased completely to the 0V voltage. Due to LC resonance, a current flows back through the current path \textcircled{1}′. Since the current paths \textcircled{1}′ and \textcircled{1}″ are repeatedly formed, the voltage at the X electrode of the panel capacitor Cp stabilizes about the Ve voltage (i.e., the Vs/2 voltage) initially charged in the power recovery capacitor C1.

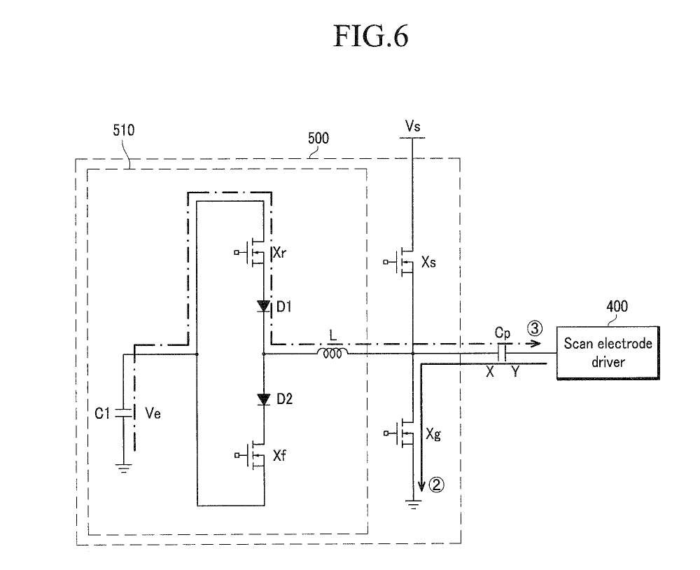

Subsequently, during the period T2, the transistors Xr and Xf are turned off, and the transistor Xg is turned on. Then, as shown in FIG. 6, a current path \textcircled{2} including the X electrode of the panel capacitor Cp, the transistor Xg, and ground is formed. The voltage at the X electrode of the panel capacitor Cp is decreased to the 0V voltage by the current path \textcircled{2}.

Subsequently, during the period T3, the transistor Xg is turned off, and the transistor Xr is turned on. Thereby, as shown in FIG. 6, a current path \textcircled{3} including a ground, the power recovery capacitor C1, the transistor Xr, the diode D1, the inductor L, and the X electrode of the panel capacitor Cp is formed. By the current path \textcircled{3}, an LC resonance circuit is formed, and the voltage at the X electrode of the panel capacitor Cp is increased to be close to the Vs voltage.

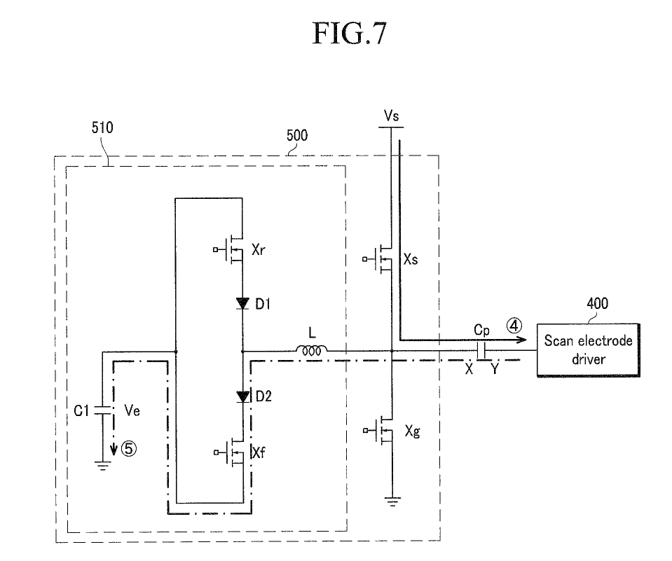

During the period T4, the transistor Xr is turned off, and the transistor Xs is turned on. Thereby, as shown in FIG. 7, a current path \textcircled{4} including the power source Vs, the transistor Xs, and the X electrode of the panel capacitor Cp is formed. The Vs voltage is applied to the X electrode of the panel capacitor Cp through the current path \textcircled{4}.

Subsequently, during the period T5, the transistor Xs is turned off, and the transistor Xf is turned on. As shown in FIG. 7, a current path \textcircled{5} including the X electrode of the panel capacitor Cp, the inductor L, the diode D2, the transistor Xf, the power recovery capacitor C1, and ground is formed. An LC resonance circuit is formed through the current path \textcircled{5}, the voltage charged in the panel capacitor Cp is discharged, and the voltage at the X electrode of the panel capacitor Cp is decreased to be close to the 0V voltage.

Subsequently, periods T2 to T5 are repeated. During the period T2, the transistor Xf is turned off, the transistor Xg is turned on, and the 0V voltage is applied to the X electrode. In this manner, the plurality of sustain pulses may be applied to the X electrode during the sustain period by repeatedly performing periods T2 to T5.

Since the Ve voltage is applied to the X electrode during the bias period T1 without using a separate power source for applying the Ve voltage, the number of transistors for supplying the Ve voltage may be reduced. In this case, the Ve voltage is changed according to a voltage charged in the power recovery capacitor C1. In a first exemplary embodiment of the present invention, the power recovery capacitor C1 is set to be charged with the Vs/2 voltage.

An alternate method for establishing the Ve voltage, which is charged in the power recovery capacitor C1, according to the weight values of subfields of a frame will now be described.

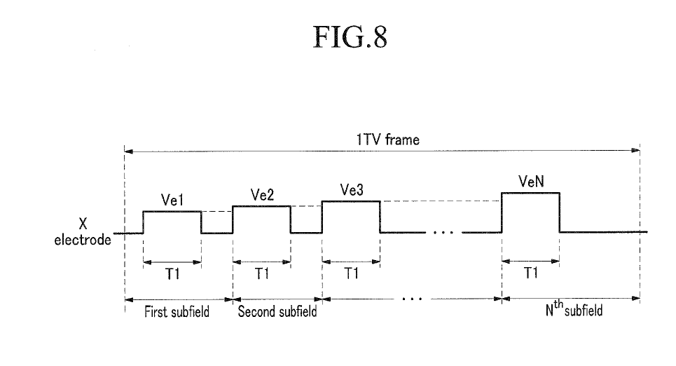

FIG. 8 is a diagram representing a waveform of the X electrode of the plasma display according to a second exemplary embodiment of the present invention. In FIG. 8, a plurality of subfields of one frame are shown, and only the waveform applied to the X electrode during each bias period T1 of the plurality of subfields is illustrated. Here, a first subfield is a subfield of a unit light (i.e., a subfield having a lowest weight value). A second subfield is a subfield having a weight value that is greater than the lowest weight value, and the weight value increases for each subsequent subfield in a frame. That is, an nth subfield that is the last subfield in the frame has a maximum, or largest, weight value.

As shown in FIG. 8, according to the second exemplary embodiment of the present invention, a Ve1 voltage is applied to the X electrode during the bias period T1 of the first subfield having the lowest weight value, and a Ve2 voltage that is higher than the Ve1 voltage is applied to the X electrode during the bias period T1 of the second subfield having a weight value that is greater than the lowest weight value. Likewise, a VeN voltage that is higher than the Ve2 voltage is applied to the X electrode during the bias period T1 of the n^{th} subfield having the largest weight value. As described, the Ve voltage applied to the X electrode during the bias period T1 increases as the weight value of the corresponding subfield increases.

Generally, as the unit light of the first subfield decreases, grayscale performance for low gray levels increases. Accordingly, as shown in FIG. 8, the Ve1 voltage, the lowest voltage among the Ve voltages, is applied to the X electrode during the bias period T1 of the first subfield. Thereby, a weak discharge is generated between the X and Y electrodes and between the X and A electrodes. Overcharge and misfiring may be prevented by the weak discharge during a subsequent sustain period. In addition, since the light caused by the weak discharge is low, the performance of expressing low gray levels is increased. Further, the VeN voltage, the highest voltage among the Ve voltages, is applied to the X electrode during the bias period T1 of the subfield having the maximum weight value. Thereby, a strong discharge stronger than that of the first subfield is generated between the X and Y electrodes and between the X and A electrodes. Accordingly, low discharge and misfiring may be prevented by the strong discharge during a subsequent sustain period.

As described, to apply the different Ve voltages according to the subfields, the voltage charged in the power recovery capacitor C1 is established differently. That is, the controller 200 transmits a control signal for controlling the power recovery capacitor C1 to be charged with the Ve1 voltage to the sustain electrode driver 500 during the bias period T1 of the first subfield. The controller 200 then transmits a different control signal for controlling the power recovery capacitor C1 to be charged with the Ve2 voltage to the sustain electrode driver 500 during the bias period T1 of the second subfield. Similarly, the controller 200 transmits a control signal for controlling the power recovery capacitor C1 to be charged with the VeN voltage to the sustain electrode driver 500 during the bias period T1 of the n^{th} subfield.

The Ve1 voltage to the VeN voltage are respectively established to be voltages between the 0V voltage and the Vs voltage. Accordingly, the controller 200 controls switching times of the transistors Xf and Xr according to the Ve voltage charged in the power recovery capacitor C1 during the sustain period so as to apply a sustain pulse to the X electrode. A method for controlling the switching time is well know to a person of ordinary skill in the art, and therefore a detailed description thereof will be omitted.

Since the driving circuit for applying the sustain discharge voltage to the sustain electrode is used to apply a voltage to the sustain electrode during the falling period of the reset period and the address period in lieu of using, for example, an additional power source and additional transistors, the cost may be reduced. In addition, since the voltages applied to the sustain electrode during the falling period of the reset period and the address period may be differently established according to the weight value of the subfield, the discharge may be more stably generated.

While this invention has been described with respect to certain embodiments, it is to be understood that the invention is not limited to the disclosed embodiments, but, instead is intended to cover various modifications and equivalent arrangements included within the spirit and scope of the appended claims and their equivalents.

What is claimed is:

1. A driving method for a plasma display comprising a sustain electrode for forming a panel capacitor, an inductor having a first terminal coupled to the sustain electrode, and a power recovery capacitor having a first terminal coupled to a second terminal of the inductor, the driving method comprising:
charging a first voltage in the power recovery capacitor in an address period of a first subfield;
forming a first current path through the power recovery capacitor, the inductor, and the panel capacitor in the address period of the first subfield;
forming a second current path through the panel capacitor, the inductor, and the power recovery capacitor in the address period of the first subfield;
repeatedly passing current through the first current path and the second current path by utilizing resonance between the inductor and the panel capacitor to apply the first voltage to the sustain electrode in the address period of the first subfield;
charging a second voltage that is higher than the first voltage in the power recovery capacitor in an address period of a second subfield having a weight value greater than a weight value of the first subfield;
forming a third current path through the power recovery capacitor, the inductor, and the panel capacitor in the address period of the second subfield;
forming a fourth current path through the panel capacitor, the inductor, and the power recovery capacitor in the address period of the second subfield; and
repeatedly passing current through the third current path and the fourth current path by utilizing resonance between the inductor and the panel capacitor to apply the second voltage to the sustain electrode in the address period of the second subfield.

2. The driving method of claim 1, further comprising, in an address period of a third subfield having a weight value that is greater than that of the second subfield:
charging a third voltage that is greater than the second voltage in the power recovery capacitor;
forming a fifth current path through the power recovery capacitor, the inductor, and the panel capacitor;
forming a sixth current path through the panel capacitor, the inductor, and the power recovery capacitor; and
repeatedly passing current through the fifth current path and the sixth current path by utilizing resonance between the inductor and the panel capacitor to apply the third voltage to the sustain electrode.

3. The driving method of claim 1, wherein said forming the first current path comprises turning on a first switch having a first terminal coupled to the second terminal of the inductor and a second terminal coupled to the power recovery capacitor, and wherein said forming the second current path comprises turning on a second switch having a first terminal coupled to the second terminal of the inductor and a second terminal coupled to the power recovery capacitor.

4. The driving method of claim 1, wherein said forming the third current path comprises turning on a first switch having a first terminal coupled to the second terminal of the inductor and a second terminal coupled to the power recovery capacitor, and wherein said forming the fourth current path comprises turning on a second switch having a first terminal coupled to the second terminal of the inductor and a second terminal coupled to the power recovery capacitor.

5. The driving method of claim 1, further comprising, in a falling period of a reset period of the first subfield, repeatedly passing current through the first current path and the second current path by utilizing the resonance between the inductor and the panel capacitor to apply the first voltage to the sustain electrode.

6. The driving method of claim 1, further comprising, in a falling period of a reset period of a second subfield, repeatedly passing current through the third current path and the fourth current path by utilizing the resonance between the inductor and the panel capacitor to apply the second voltage to the sustain electrode.

7. The driving method of claim 1, further comprising applying a sustain pulse by alternately applying a third voltage and a fourth voltage that is higher than the third voltage to the sustain electrode during a sustain period of the first subfield,
wherein the first voltage is between the third voltage and the fourth voltage.

8. The driving method of claim 7, wherein said applying the sustain pulse comprises:
increasing a voltage at the sustain electrode from the third voltage to the fourth voltage by utilizing the resonance between the inductor and the panel capacitor;
applying the fourth voltage to the sustain electrode;
decreasing the voltage at the sustain electrode from the fourth voltage to the third voltage by utilizing the resonance between the inductor and the panel capacitor; and
applying the third voltage to the sustain electrode.

9. The driving method of claim 1, further comprising applying a sustain pulse by alternately applying a third voltage and a fourth voltage that is higher than the third voltage to the sustain electrode during a sustain period of the second subfield, wherein the second voltage is between the third voltage and the fourth voltage.

10. The driving method of claim 9, wherein said applying the sustain pulse comprises:
increasing the voltage at the sustain electrode from the third voltage to the fourth voltage by utilizing the resonance between the inductor and the panel capacitor;
applying the fourth voltage to the sustain electrode;
decreasing the voltage at the sustain electrode from the fourth voltage to the third voltage by utilizing the resonance between the inductor and the panel capacitor; and
applying the third voltage to the sustain electrode.

11. A plasma display comprising:
a sustain electrode;
a first switch coupled between the sustain electrode and a first power source for supplying a first voltage;
a second switch coupled between the sustain electrode and a second power source for supplying a second voltage that is lower than the first voltage;
an inductor having a first terminal coupled to the sustain electrode;
a power recovery capacitor configured to be charged with a third voltage between the first and second voltages in a first subfield, and configured to be charged with a fourth voltage that is higher than the third voltage in a second subfield having a weight value greater than a weight value of the first subfield;
a third switch having a first terminal coupled to a second terminal of the inductor and a second terminal coupled to the power recovery capacitor; and
a fourth switch having a first terminal coupled to the second terminal of the inductor and a second terminal coupled to the power recovery capacitor,
wherein the third and fourth switches are configured to be turned on in an address period of the first subfield to apply the third voltage to the sustain electrode, and
wherein the third and fourth switches are configured to be turned on in an address period of the second subfield to apply the fourth voltage to the sustain electrode.

12. The plasma display of claim 11, wherein the third switch is configured to be turned on to form a first current path including the power recovery capacitor, the third switch, the inductor, and the sustain electrode, wherein the fourth switch is configured to be turned on to form a second current path including the sustain electrode, the inductor, the fourth switch, and the power recovery capacitor, such that current is repeatedly transmitted through the first and second current paths in the address period of the first subfield to apply the third voltage to the sustain electrode.

13. The plasma display of claim 11, wherein the third switch is configured to be turned on to form a first current path including the power recovery capacitor, the third switch, the inductor, and the sustain electrode, wherein the fourth switch is configured to be turned on to form a second current path including the sustain electrode, the inductor, the fourth switch, and the power recovery capacitor, such that current is repeatedly transmitted through the first and second current paths in the address period of the second subfield to apply the fourth voltage to the sustain electrode.

14. The plasma display of claim 11, further comprising:
a first diode having an anode coupled to the first terminal of the third switch and a cathode coupled to the second terminal of the inductor; and
a second diode having a cathode coupled to the first terminal of the fourth switch and an anode coupled to the second terminal of the inductor.

15. The plasma display of claim 11, wherein the power recovery capacitor is configured to be charged with a fifth voltage that is higher than the fourth voltage in a third subfield having a weight value that is greater than that of the second subfield, and the third and fourth switches are configured to be turned on in an address period of the third subfield to apply the fifth voltage to the sustain electrode.

16. The plasma display of claim 11, wherein the third and fourth switches are configured to be turned on in a falling period of a reset period of the first subfield to apply the third voltage to the sustain electrode, and the third and fourth switches are configured to be turned on in a falling period of a reset period of the second subfield to apply the fourth voltage to the sustain electrode.
